(19) United States
(12) Patent Application Publication
(10) Pub. No.: US 2013/0108364 A1
(43) Pub. Date: May 2, 2013

(54) METHOD AND MATERIAL FOR PAVING A SURFACE

(71) Applicant: Barth Campbell, Headsburg, CA (US)

(72) Inventor: Barth Campbell, Headsburg, CA (US)

(21) Appl. No.: 13/567,461

(22) Filed: Aug. 6, 2012

Related U.S. Application Data
(60) Provisional application No. 61/559,068, filed on Nov. 12, 2011.
(60) Provisional application No. 61/551,838, filed on Oct. 26, 2011.

(51) Int. Cl. C09D 189/00; E01C 15/00

(52) U.S. Cl. 404/82; 106/157.71

(57) ABSTRACT

A method and material for paving a surface, such as a dirt trail, is disclosed. The method includes obtaining raw chert material which is composed primarily of particles of gravel, sand, and clay obtained from a quarry or mine, and which has been screened to remove particles of a size of one inch or more. The screened chert is mixed to achieve consistency of the material, then mixed with a predetermined quantity of an aqueous enzyme solution. The aqueous enzyme solution contains an enzyme fluid mixed with water in the ratio of 0.02 to 5 gallons of enzyme fluid to 400 to 1000 gallons of water. The material-solution mix is than applied to a surface in layers and compacted to achieve a finished thickness of about 6 to 10 inches. After a delay of 48 hours, the paved surface is usable by equipment and vehicles.

### CROSS-REFERENCE TO RELATED APPLICATIONS

This application claims the benefit, pursuant to 35 U.S.C. §119(e), of U.S. Provisional Patent Application No. 61/551,838, filed Oct. 26, 2011 entitled “Method and Material for Paving” and U.S. Provisional Patent Application No. 61/559,068, filed Nov. 12, 2011 also entitled “Method and Material for Paving,” which are hereby incorporated by reference in their entireties.

### FIELD OF THE INVENTION

The present invention generally relates to paving a surface and more particularly to paving surfaces such as trails in parks with a resilient, lasting and an environmentally acceptable material.

### DESCRIPTION OF THE RELATED ART

There are many trail tread designs that are on the market and have been put to use. Various small granular quarry fines, tree sap infused fine granular material, and decomposed granite mixed with cements have been used in hopes of achieving the many requirements a trail tread needs to fulfill. None have been a perfect fit. For example, the Natural Pave System uses quarry fines of several different types with an unknown binder. The system is a bit tricky because it must be installed within 24 hours or less of mixing. This system is also very unstable when installed at temperatures below 68 degrees and when exposed to the elements. For example, the binding capabilities of the material deteriorate with moisture, including coastal fog. In addition, the cost of this system exceeds $250 per ton installed.

Another attempt at a suitable trail tread was tried by adding resin or tree sap to decomposed granite. The problem with this method is the surface of the trail cracks and begins to break down as soon as the second year. This leads to high maintenance costs and ongoing repairs. The resin product is also very temperature sensitive, particularly when installed below 60 degrees. When it is installed above 90 degrees the surface becomes tacky and sticky.

Decomposed granite without a binder has also been tried. This surface tends to be unstable in the environment, creating erosion from wind and water action as well as high pedestrian traffic. The instability creates high maintenance costs as well as safety issues from the fine grains accumulating on the surface and creating a slip hazard.

Thus, the need remains for an environmentally friendly trail surface that can withstand heavy traffic use and meet state and federal guidelines for Americans with Disability Act (ADA) and Accessible Guidelines for Outdoor Developed Areas (AGODA) standards. Not only does a trail tread need to hold up to the wear and tear of vehicles, horses, bicycles, and pedestrians, but it also needs to be inviting for the user and match the natural environment.

### BRIEF SUMMARY OF THE INVENTION

The present invention's environmental qualities and ability to maintain structural integrity and stability make it superior to other products on the market. It is processed specifically to meet the durability standards required for trails, roads, and parking lots and other paved surfaces. The mix holds up to ADA and AGODA requirements, which many clients such as the National Park Service require. The present invention is strong enough to withstand impacts from vehicles, horses, bicycles, and pedestrians, while still maintaining its structural integrity and appearance. It also has a high tolerance for harsh weather environments ranging from freezing temperatures to extreme heat during installation and as a finished product. This resistance to environmental conditions and users decreases the need for maintenance and thus saves resources in the form of money and natural resources. Once installed, the tread requires half the maintenance than other surfacing materials. Its ability to hold up also keeps the surrounding environment from being impacted by erosion, making the present invention a great choice for a trail traveling through sensitive areas and waterways.

The present invention's natural minerals and ingredients eliminate any chance of pollution leaching or contaminated run-off. It is free of heavy metals, toxins, pesticides, and other pollutants. This is proven in the MSDS forms of the enzyme additive that is used. Further, heat is one if the pollutants that Park Tread does not release into the surroundings. A trail made out of the material of the present invention has a high albedo, which means it is highly reflective and will keep the near surface air cool. When a trail is cool so are the trails users, including the feet of any animals on the path. Any water flowing across or near the trail will not increase in heat due to the trail and will not impact the temperatures of the nearby waterways, shocking aquatic life. An area that chooses to surface with the present invention over another product with a lower reflectivity, such as asphalt, will also benefit in energy savings because air conditioning will not be needed as much near this cool surface. Cooler surface air temperatures also keep ozone from forming near the ground and emissions from vehicles evaporating into the atmosphere. (United States Environmental Protection Agency, 2011)

Not only will users and surrounding habitat enjoy a cool experience, users will enjoy its natural looking color and surface. The surface becomes part of the environment, rather than standing out against the settings. The present invention blends into the environment aesthetically and structurally allowing users to experience sensitive ecosystems and watersheds with minimal impact. The present invention allows trails to be built and exist for generations in areas that site conditions might not have otherwise allowed.

One embodiment of the present invention is a method of paving a surface. A raw chert material is obtained from a suitable location, such as a quarry, where the material includes particles of rock, sand, and clay. The particles of the raw chert material can be screened down to a size passing through a mesh with openings of about one-inch, ¾ inch, ½ inch, ⅜ inch or ¼ inch or less. If the raw chert is screened into different sizes, the screening process breaks down the fine and clays in the material, then selected sizes of the screened material (for example, all sizes up to 1 inch, ¾ inch, ½ inch or even ¼ inch) can be recombined to form material to be mixed with an aqueous enzyme solution. In one embodiment, the screened chert is recombined such that 100% passes a 25 mm screen, 75-90% passes a 12.5 mm screen, 30-50% passes a 4.75 mm screen, 20-35% passes a 2.36 mm screen and less than 15% passes a 0.075 mm screen. In another embodiment, the screened chert can have about 50% or less passing a #4 screen (4.75 mm), and about 25% or less passing through a #10 screen (2 mm), about 20% or less passing though a #20 screen (0.841 mm), and 15% or less passing through a #30 screen (0.595 mm). These proportions will be varied if the largest particle size is chosen to be more or less than 1 inch, e.g. ¾ or ½ inch.

In one embodiment, the aqueous enzyme solution comprises from 0.2 to 5 gallons of enzyme fluid per 400 gallons of water, and in another embodiment, the aqueous enzyme solution comprises about 1.2 gallons of enzyme fluid per 400 to 1000 gallons water. In another embodiment, the enzyme solution is a dilution of Perma-Zyme™ as the enzyme fluid with water. Perma-Zyme™ is a brown, non-corrosive, non-flammable soil stabilizing fluid made up of organic materials (including a substantial presence of methyl-ethyl ketone) derived from a natural fermentation process, and other proprietary ingredients. It is available from Pacific Enzymes at www.pacificenzymes.com. More specifically, the principal ingredients of Perma-Zymes include miscellaneous enzymes produced from food products. Perma-Zyme apparently acts upon organic fines contained in the chert through a catalytic bonding process, producing a strong cementation action. Unlike inorganic or petroleum based products which temporarily hold soil materials together, the aqueous enzyme solution causes the chert to bond during compaction into a dense permanent base which resists water penetration, weathering and wear. Solutions of other enzymatic compounds also high in methyl ethyl ketone or other solvents containing from 1 to 7 carbon atoms may also be used in place of Perma-Zyme, as long as the effect is to lower the surface tension of water to promote fast and thorough penetration and dispersal of moisture along with the needed enzymatic activity. This action causes hydrated clay particles to be pressed into and to fill the voids throughout the soil, thus forming a tight, dense permanent stratum.

The aqueous enzyme fluid is applied to the screened chert in a predetermined ratio, of from 3 to 20 gallons of aqueous enzyme solution to cubic yard of chert, and in another embodiment, the ratio is from 5 to 10 gallons of solution to cubic yard of chert. Yet another embodiment is for the ratio to be about 7.0 to 10 gallons of solution to each cubic yard of chert.

The material-solution mix can be applied to the surface to be paved in a series of layers, or lifts, and each lift of said material-solution mix can be compacted to reach a final thickness of any depth over 2 inches, more commonly 4 to 8 inches. In another embodiment, an overall combined thickness of the applied lifts is about 6 inches. In another embodiment, weather conditions permitting, one or more lifts can be applied to the surface before compacting. After all of the lifts are applied, use of the applied material should be delayed for a suitable period of time, e.g., 1 to 3 days, and in another embodiment, a delay of using equipment or vehicles on the surface for 2 days is provided for.

Another embodiment of the present invention is a material for paving a surface. The material includes screened or refined chert and an aqueous enzyme solution. The refined chert can be formed from combining a plurality of batches of screened raw chert, the batches having been mixed to achieve a uniform distribution of particle size and to break down the rock particles and clays therein. In another embodiment, the screened chert need only be screened to remove overly large objects from the material, for example, objects over 1/4, 3/8, 1/2 or 1 inch in cross section. The chert material is then combined with an aqueous enzyme solution in the proportions discussed above.

### BRIEF DESCRIPTION OF THE DRAWINGS

These and other features, aspects and advantages of the present invention will become better understood with regard to the following description, appended claims, and accompanying drawings where:

FIG. 1 shows a flow chart of an embodiment of the present invention;

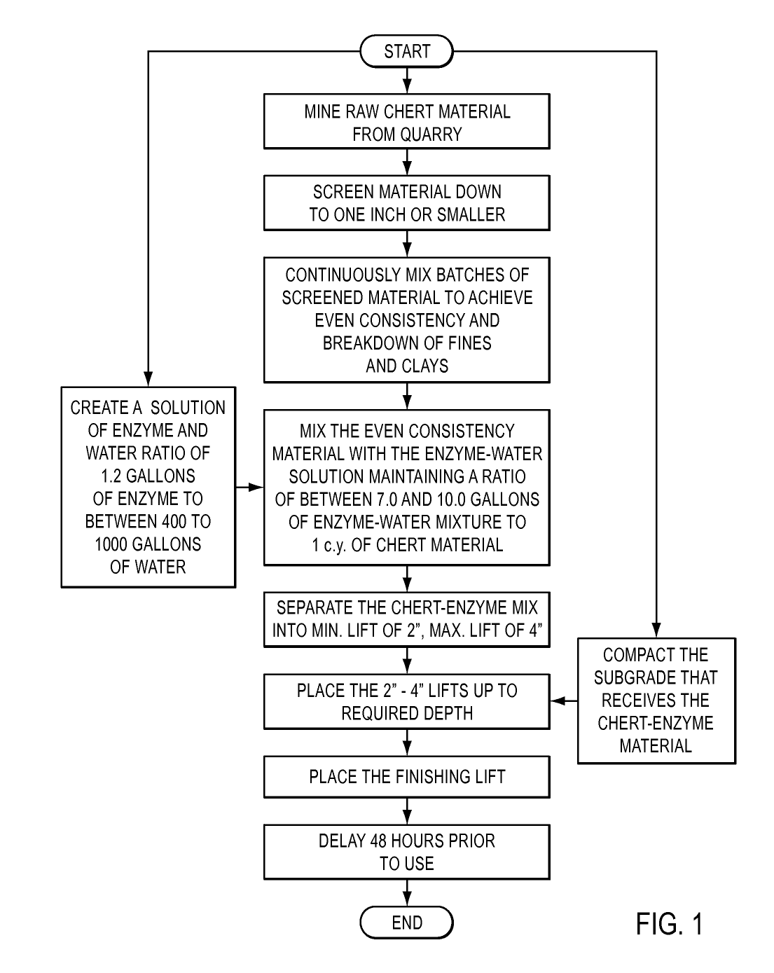

FIG. 2 shows a distribution of particle sizes in the chert;

FIG. 3 shows the mineralogical composition of the chert;

FIG. 4 shows an elemental composition of the chert; and

FIG. 5 shows Atterberg limits of the chert.

### DETAILED DESCRIPTION OF THE INVENTION

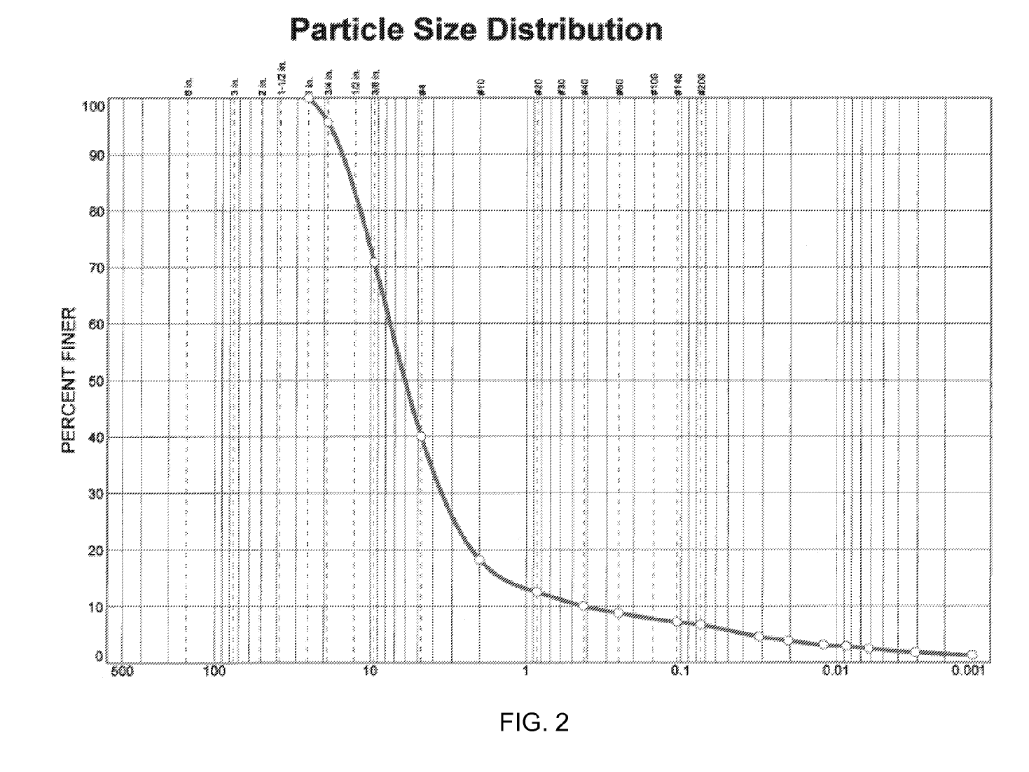

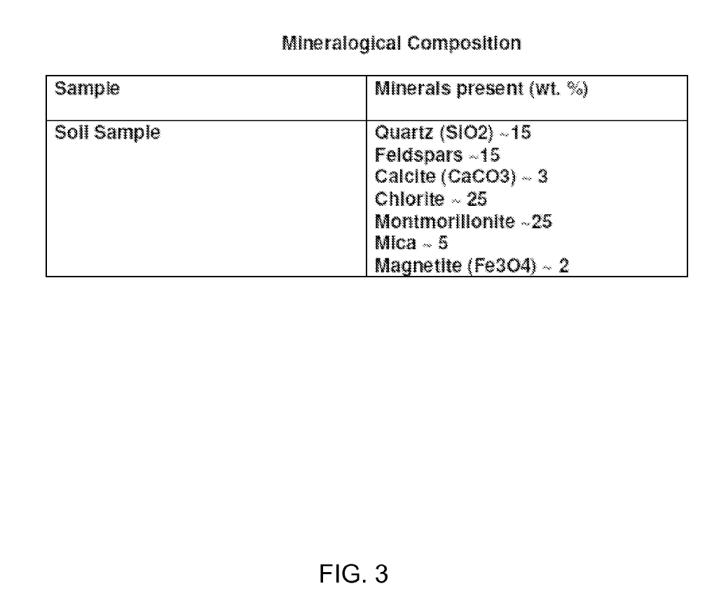

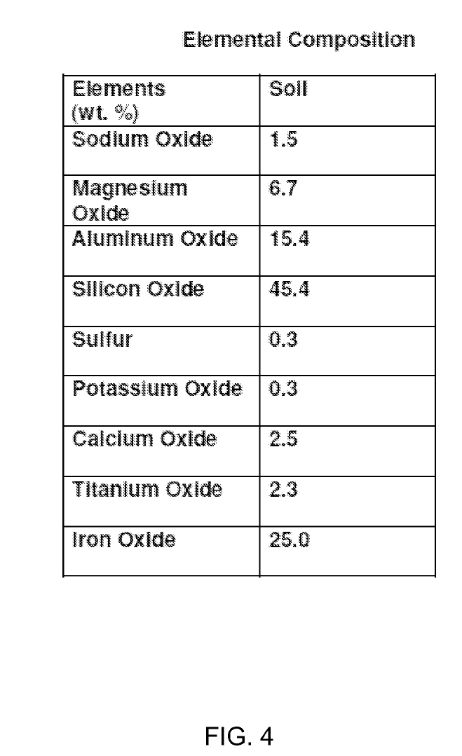

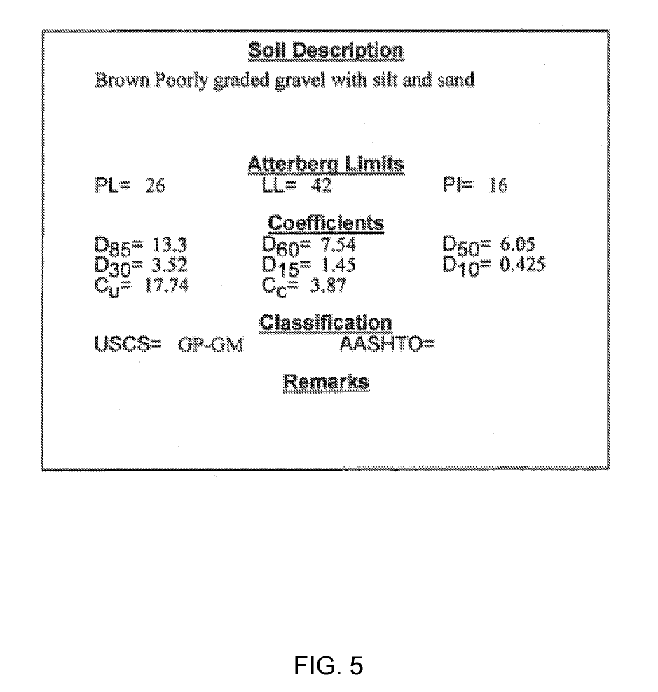

The raw chert is commonly obtained, directly or indirectly, from a quarry, and it may be advantageous to select a specific vein of chert from the quarry to provide the optimal raw material for making the paving material. This selection process can be done by the preparer or an assistant prior to the purchase of an individual order of chert material. The inspection can be done for not only quality assurance but for certainty that the proper combinations of raw minerals are used. In one embodiment, the chert is made of the following particle sizes by percentage: (a) gravels having a particle size between about 25.4 mm and 5 mm; (b) a variety of sands (fine, medium and coarse) having a particle size between about 5 mm and about 0.1 mm; (c) silts and clay having a particle size between about 0.1 mm and 0.001 mm, according to FIG. 2. The minerals present by approximate weight percentage are Montmorillonite (25%), Chlorite (25%), Quartz (15%), Feldspar (15%), Mica (5%), Calcite (3%), and Magnetite (2%), according to FIG. 3. These minerals combine to create a chert whose chemical composition by weight is mostly silicon oxide (45.4%), iron oxide (25%), aluminum oxide (15.4%), and magnesium oxide (6.7%), along with small amounts of calcium oxide (2.5%), titanium oxide (2.3%), sodium oxide (1.5%), sulfur (0.3%), and potassium oxide (0.3%), according to FIG. 4. Additionally, the chert has a plasticity index of 16, indicating that the chert has medium plasticity, a liquid limit of 42, and a plastic limit of 26, according to FIG. 5. The mineral composition can vary up to 10% or more in either direction for each mineral, depending on the specific material and quarry location. Important coefficients for the soil include the uniformity coefficient Cu and the coefficient of gradation Cc. The uniformity coefficient is approximately 17.74 and the coefficient of gradation Cc is approximately 3.87, according to FIG. 5.

After the vein of material is selected, the inventor oversees the excavation by spot-checking the site as the chert is excavated. The selected chert is then screened, and hauled to a storage yard. As the trucks import the material to the storage yard, a three yard front-loader continually mixes each additional truck load with the prior ones until the import of a given quantity of chert is complete. As a result of this continuous mixing, the chert develops an even consistency. The fines and clays can be broken down during this mixing process, providing a more uniform mix with superior binding effects. The chert is then placed in a protected location such as a rock bunker, where it is covered using black plastic held down by sand bags and plastic rope. The plastic provides protection from moisture. It is critical that the chert remain dry while in storage. If the chert were to become wet, the moisture in the chert would act as a repellant to the subsequent treatment of the chert with the enzyme solution described below.

When a project requires the use of chert mix, the chert is uncovered and either premixed with an enzyme solution at a contractor's facility or transported to the project site where it is mixed with the enzyme solution. The chert mix must be used within about forty eight hours after the enzyme solution has been added to the chert. In one embodiment, the enzyme solution is a dilution of Perma-Zyme™ with water. Perma-Zyme™ is a brown, non-corrosive, non-flammable soil stabilizing fluid made up of organic materials derived from a natural fermentation process.

A mixture ratio of about 1.0 to 1.2 gallons of the enzyme to every 400 to 1,000 gallons of water can be used for temperatures in the range of about 55 degrees to 70 degrees F. For a temperature in the range of 70 to 85 degrees, a ratio of 1.0 gallon of Perma-Zyme™ to 650 gallons of water is employed. For a temperature range of 85 to 105 degrees, a ratio of 1.0 gallon to 900 to 1,000 gallons of water is employed. Once the diluted mixture is completed, the amending of the chert process can begin. After the material is separated from the main stock pile, a water-enzyme solution is pumped from a 1½-inch fire hose connected to a portable water tank containing the enzyme solution. A ratio of approximately 7.2±5% gallons of the enzyme mixture to 1 cubic yard of chert is maintained during the mixing at 55 to 70 degrees F., with it being understood that a higher proportion of water will be employed at higher temperatures. The amount of enzyme-water mixture is a critical part of the process. Visual and hand molding indicates the proper amount of solution blended with the chert. Identification of the proper solution/chert mixture is done by separating the quantity of material needed for an installation. Continuous mixing using a frontend loader or a rotational drum mixer must be done until material has uniform moisture content throughout. When the Chert mix is complete, one should be able to form the mix in a ball in the hand and have the mixture stay together without leaving the hands wet or muddy in appearance. If the mix becomes too wet, dryer material from the stock pile can be added to the mixture. In order to properly mix the Chert mix, the individual must be trained in the correct appearance and performance of the product.

In order for the subgrade to receive the Chert mix, the subgrade should be compacted to about 95% and should be uniform and at an even grade, with irregularities less than from 0.50 to 0.75 inches. The Chert mix can be placed in lifts between two and four-inch thick, evenly placed. In one embodiment, subsequent lifts should not be placed until the previous lift has been compacted. A final finishing lift should bring the trail to its final section, varying between 4 inches to any required depth.

The mixture and compaction process is sensitive to temperature, relative humidity, and direct rain impact. This sensitivity must be taken into account during the installation process. For every degree of temperature decrease from 70 degrees the compaction time should increase by one to five minute(s), for twenty (20) minutes, for every 60 to 100 feet squared of area. It is preferred that the compaction time not be less than about 5% to 8% of the specified times for best results. For example, it commonly takes about eighteen (18) to thirty minutes (30) to compact each sixty to one hundred square feet of area on a sixty (60) to seventy (70) degree F. day using a 4,000 lb. to 8,000 lb. vibratory roller. A clear weather window with no rain forecast for thirty-six (36) to forty-eight (48) hours is recommended for the placement of the Chert mix.

The need for compaction cannot be overemphasized. When the surface is properly compacted, there is a smooth even sheen to the finished tread, with limited rocks exposed.

Once the final lift has been compacted all heavy equipment and vehicle traffic should remain off the surface for approximately forty-eight (48) hours or more, after which time the surface is ready for use.

If needed, repairs or patching can be accomplished by saw-cutting using a diamond imbedded carbon wet-cut blade. First, the perimeter of the section required for removal is saw cut. Next, the section is removed by hand or with equipment. Next, mix the proper volume of chert is mixed and installed using the same methods as described above.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method of paving a surface, said method comprising:
mixing screened chert material comprising rock, sand and clay with a predetermined quantity of an aqueous enzyme solution to form a material-solution;
applying at least one layer of the material-solution to the surface to be paved to form a lift;
compacting the one or more applied lifts to form the paved surface.

2. The method of claim 1 wherein the predetermined quantity is about 5 to 10 gallons of aqueous enzyme solution per cubic yard of screened chert material.

3. The method of claim 1 wherein the predetermined quantity is about 7 to 7.5 gallons of aqueous enzyme solution per cubic yard of screened chert material.

4. The method of claim 1 wherein the aqueous enzyme solution comprises from 0.2 to 5 gallons of enzyme fluid per 400 to 1000 gallons of water.

5. The method of claim 3 wherein the aqueous enzyme solution comprises about 1.2 gallons of enzyme fluid per 400 gallons of water.

6. The method of claim 1 wherein the thickness of the one or more lifts after compacting is a total of about 3-10 inches.

7. The method of claim 1 wherein the thickness of the lifts after compacting is about 6 inches.

8. The method of claim 1 further comprising delaying use of the paved surface for a period of about 1-3 days.

9. The method of claim 2, wherein the enzyme fluid is Perma-Zyme™ 11X.

10. The method of claim 1, wherein the chert primarily comprises silicon oxide and iron oxide.

11. A material for paving a surface, said material comprising:
A screened chert composition comprising rock, sand and clay, to which is applied a predetermined quantity of aqueous enzyme solution.

12. The material of claim 11 wherein the aqueous enzyme solution comprises from 0.2 to 5 gallons of an enzyme fluid per 400 to 1000 gallons of water.

13. The material of claim 11 wherein the aqueous enzyme solution comprises about 1.2 gallons of an enzyme fluid per 400 gallons of water.

14. The material of claim 11 wherein the aqueous enzyme solution is applied to said screened chert in the ratio of from 3 to 20 gallons of solution to each cubic yard of screened chert.

15. The material of claim 11 wherein the aqueous enzyme solution is applied to said screened chert in the ratio of about 5 to 10 gallons of solution to each cubic yard of screened chert.

16. The material of claim 11 wherein the aqueous enzyme solution is applied to said screened chert in the ratio of about 7 to 7.5 gallons of solution to each cubic yard of screened chert.

17. The material of claim 11 wherein the screened chert has been screened to remove particles over 1 inch in size.

18. The material of claim 11 wherein the screened chert has been screened to remove particles over ¼ inch in size.

19. The material of claim 12, wherein the enzyme fluid is Perma-Zyme™ 11X.

20. The material of claim 11 wherein the aqueous enzyme solution comprises about 1.2 gallons of enzyme fluid per 400 gallons of water and is applied to said refined chert in the ratio of about 7.2 gallons of solution to each 1 cubic yard of screened chert.
